(19) United States
(12) Patent Application Publication
(10) Pub. No.: US 2015/0197687 A1
(43) Pub. Date: Jul. 16, 2015

(54) Photoluminescence-Enhanced Sandwich Structure of Luminescent Films and Method

(71) Applicant: Beijing University of Technology, Beijing (CN)

(72) Inventors: Yin-zhou Yan, Beijing (CN); Yong Zeng, Beijing (CN); Yan Zhao, Beijing (CN); Ling-fei Ji, Beijing (CN); Yi-jian Jiang, Beijing (CN)

(73) Assignee: Beijing University of Technology, Beijing (CN)

(21) Appl. No.: 14/255,958

(22) Filed: Apr. 18, 2014

(30) Foreign Application Priority Data
Jan. 13, 2014 (CN) 201410015279.0

(51) Int. Cl. C09K 11/02; B05D 1/18; B05D 1/02; C09K 11/54; B05D 3/00

(52) U.S. Cl. CPC C09K 11/025; C09K 11/54; B05D 3/007; B05D 1/02; B05D 1/18

(57) ABSTRACT

A sandwich structure for enhancement of photoluminescence (PL) from luminescent films and the corresponding preparation method are disclosed. The sandwich structure comprises a support, a luminescent film grown on the support, and a close-packed dielectric microsphere monolayer deposited onto the luminescent film. The microspheres have high transmittance excitation light and emitted light, respectively. The low price of dielectric microspheres is beneficial to industrial applications. The stable chemical properties of dielectric microspheres make PL enhanced in a long term. Both metal and non-metal materials can be used as the support in the sandwich structure. These features significantly improve the technique of PL enhancement for luminescent films.

This application claims priority to Chinese Patent Application Ser. No. CN201410015279.0 filed 13 Jan. 2014.

### FIELD OF THE INVENTION

The present invention relates to photoluminescence (PL) enhancement of luminescent films, and more particularly, to techniques for fabricating microsphere-based sandwich structures for PL enhancement.

### BACKGROUND OF THE INVENTION

The spectrum of photoluminescence (PL) is an important method to character material properties as well as to investigate electron states of luminescent semiconductors. The PL spectrum can provide the structure, chemical composition and atomic arrangement of material without damage. Therefore, the PL spectrum has been widely used in physics, material science, chemistry, biology and medical science. However, the major obstacle to the PL measurement is the low sensitivity for most materials due to their low PL intensity.

Surface plasmon (SP) mediated PL enhancement has been widely employed. When the electromagnetic (EM) waves arrive onto the metal surface, the free electrons in the surface of metal could be resonated once the EM frequency matches the inherent frequency of free electrons. Such a resonance can significantly enhance the EM intensity around the metal and hence dramatically increase the PL intensity from the luminescent material. In 1957, Ritchie first introduced the concept of surface plasmon resonance (SPR) and then the SRP has been applied in sensors, waveguides, spectrum enhancement, etc. In 1970, Drexhage found intensity enhancement of light emission from fluorescent materials closing to metal nanostructures. Then Lakowicz investigated the effect of fluorescent enhancement via metal nanostructures.

Recently, SP mediated PL enhancement is stimulated by coating noble metals (e.g. gold, silver, platinum) and fabricating nanostructures on luminescent material surface. Okamoto et al. deposited silver layers with 10 nm above an InGaN light-emitting layer and observed a 14-fold enhancement in peak PL intensity. Cheng et al. sputtered Ag islands on ZnO films and observed enhancement of the light emission from ZnO films by coupling through localized surface plasmons. It was found that the emission enhancement is related to the Ag island size. The band gap emission enhancement was up to 3-fold, while the defect emission was quenched. Lawrie used insulating spacer layers of MgO to tune the PL enhancement of ZnO films. Xu et al. investigated the enhancement of light emission in ZnO/Ag/ZnO nanostructures. It was found that Ag nano-islands immersed in ZnO would cause a 10-fold enhancement of visible light emission.

However, the above-mentioned SP-mediated PL enhancement is limited to the luminescent films grown on non-metal supports (e.g. alumina, silicon, etc.). When the films are grown on metal supports, the PL intensity could be reduced due to the metal supports quenching the resonated electrons. Furthermore, the high price of noble metals and the difficulty of nanostructure fabrication limit the technique of SP-mediated PL enhancement to industrial applications. Therefore, a method with low price, easy preparation, high repeatability and high stability for a large enhancement of PL from luminescent films grown on various substrates would be desirable.

### SUMMARY OF THE INVENTION

The present invention provides a sandwich structure for enhancement of photoluminescence (PL) from luminescent films grown on various supports. A method for preparation of the sandwich structure is also provided. The mechanism of PL enhancement by the structure is attributed to the near-field focusing and light collecting properties of dielectric microspheres capping on luminescent films.

In the invention, the enhanced PL structure is called the ‘sandwich structure’, which comprises a support, a luminescent film, and a close-packed dielectric microsphere monolayer. The luminescent film is grown on the support and the close-packed dielectric microsphere monolayer is deposited onto the luminescent film, by which the sandwich structure of support-film-microspheres (SLMs) is formed. The employed dielectric microspheres have high transmittance with respect to excitation light and emitted light. The diameter of dielectric microsphere ranges from 1.5 to 7.5 μm. The close-packed array of dielectric microsphere monolayer is formed by self-assembling microspheres. The detailed preparation step is as following
Step 1: Preparation of dielectric microsphere suspension. The volatile solvents are recommended to dilute microspheres as suspension, in which the microsphere concentration is 10⁴˜10⁶ μL⁻¹. The volatile solvents can be water, ethanol, isopropanol, etc.
Step 2: Dielectric microsphere suspension coating of luminescent films. The microsphere suspension is deposited onto luminescent films by drop coating, spraying, or immersing. The luminescent films can be grown on any supports, e.g. silicon, alumina, titanium, silicon carbide, etc.
Step 3: Self-assembly of microspheres. The solvent may be dried by spontaneous evaporation, heating evaporation or blowing evaporation. During solvent drying, the microspheres are self-assembled to be a hexagonal close-packed monolayer on the luminescent film via liquid surface tension. The sandwich structure of SFMs is therefore formed. A large enhancement of PL from the sandwich structure can be achieved.

Compared with SP-mediated PL enhancement, the benefits of the present invention are:
(1) The low price of dielectric microspheres makes desirable to industrial applications.
(2) Microsphere monolayer capping on luminescent film is easily prepared. The PL enhancement can be achieved once the sandwich structure is formed. It is a time-saving preparation process.
(3) The stable chemical properties of dielectric microspheres can enhance PL in a long term.
(4) The PL enhancement by the sandwich structure is suitable to any supports, either metal or non-metal materials, and any luminescent films.

### BRIEF DESCRIPTION OF THE DRAWINGS

For a complete understanding of the present invention, and the advantages thereof, the descriptions of the drawings are giving below:

FIG. 1 shows a schematic diagram illustrating a method to fabricate sandwich structures of SFMs for PL enhancement of luminescent films, on which dielectric microspheres are capped.

FIG. 2 shows a reference PL spectrum of zinc oxide (ZnO) film grown on a silicon carbide (SiC) substrate and the enhanced PL spectrum by capping with 5-μm-diameter fused silica (SiO₂) microspheres.

FIG. 3 shows a reference PL spectrum of zinc oxide (ZnO) film grown on a titanium (Ti) substrate and the enhanced PL spectrum by capping with 5-μm-diameter fused silica (SiO₂) microspheres.

FIG. 4 shows a reference PL spectrum of zinc oxide (ZnO) film grown on a graphene substrate and the enhanced PL spectrum by capping with 5-μm-diameter fused silica (SiO₂) microspheres.

FIG. 5 shows a reference PL spectrum of zinc oxide (ZnO) film grown on an alumina (Al₂O₃) substrate and the enhanced PL spectrum by capping with 5-μm-diameter fused silica (SiO₂) microspheres.

FIG. 6 shows a reference PL spectrum of zinc oxide (ZnO) film grown on a silicon carbide (SiC) substrate and the enhanced PL spectrum by capping with 7.5-μm-diameter fused silica (SiO₂) microspheres.

FIG. 7 shows a reference PL spectrum of zinc oxide (ZnO) film grown on a silicon carbide (SiC) substrate and the enhanced PL spectrum by capping with 2.5-μm-diameter fused silica (SiO₂) microspheres.

FIG. 8 shows a reference PL spectrum of zinc oxide (ZnO) film grown on a silicon carbide (SiC) substrate and the enhanced PL spectrum by capping with 1.5-μm-diameter fused silica (SiO₂) microspheres.

FIG. 9 shows a reference PL spectrum of zinc oxide (ZnO) film grown on a silicon carbide (SiC) substrate and the enhanced PL spectrum by capping with 5-μm-diameter polystyrene (PS) microspheres.

FIG. 10 shows a reference PL spectrum of zinc oxide (ZnO) film grown on a silicon carbide (SiC) substrate and the enhanced PL spectrum by capping with 5.5-μm-diameter polymethylmethacrylate (PMMA) microspheres.

### DETAILED DESCRIPTION OF PREFERRED EMBODIMENTS

The following detailed description is recommended to carry out the invention. The description is not to be taken in a limiting sense, but is intended to cover alternatives, modifications and equivalents that may be included within the spirit and scope of the various embodiments as defined by the appended claims.

In the following description of embodiments, numerous specific details are set forth in order to provide a thorough understanding of the present preparation method. However, the preparation method may be practiced without these specific details.

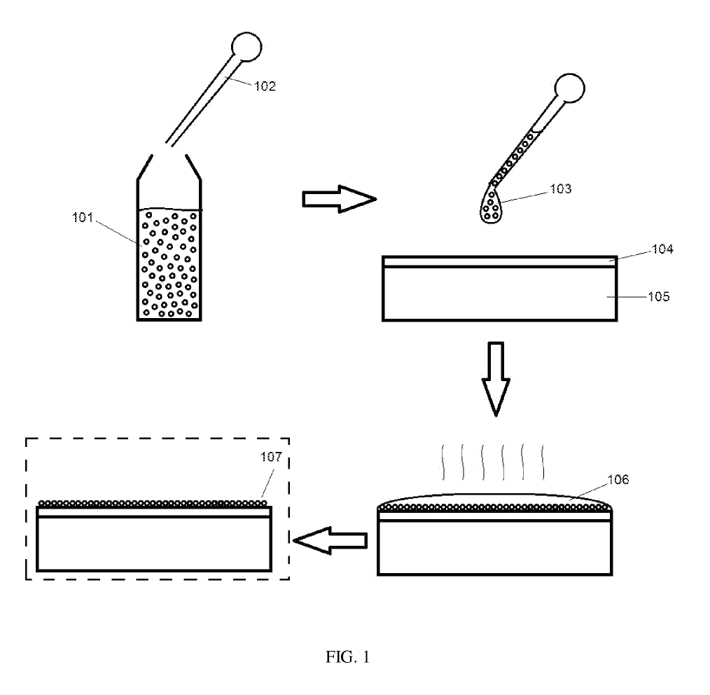

As shown in FIG. 1, dielectric microspheres are first diluted to be suspension 101. Then the suspension is drawn by a dropper 102 and deposited onto the luminescent film 104 grown on a support 105 by drop coating 103. The film surface is sufficiently wetted by the suspension drop 106. When the suspension is dried, the microspheres are self-assembled to be a close-packed monolayer 107 on the luminescent film. The sandwich structure of SFMs is therefore formed.

As disclosed herein, the solvent used in suspension 101 for dilution of dielectric microspheres is volatile. The concentration of microsphere in suspension is 10⁴˜10⁶ μL⁻¹. The volatile solvent may be water, ethanol, isopropanol, etc. The diameter of dielectric microsphere deposited onto the film surface 104 is ranging from 1.5 to 7.5 μm. The film surface can be wetted by the microsphere suspension 101 via drop coating, spraying, or immersing. Furthermore, the luminescent film 104 may be grown on any supports 105. The solvent can be dried by spontaneous evaporation, heating evaporation or blowing evaporation. The close-packed microsphere monolayer is self-assembled by liquid surface tension during solvent evaporation.

Presented here is experimental verification that PL enhancement is feasible with various sandwich structures of SFMs. The experiments were performed using commercial microspheres with diameters ranging from 1.5 to 7.5 μm (Bang Laboratories, US). A 325-nm He—Cd fibre-coupled laser (Kimmon KoHa Co., Ltd) was used as the PL excitation source. The backward scattering PL spectra were captured by a spectrograph (Princeton Instruments).

### EXAMPLE 1

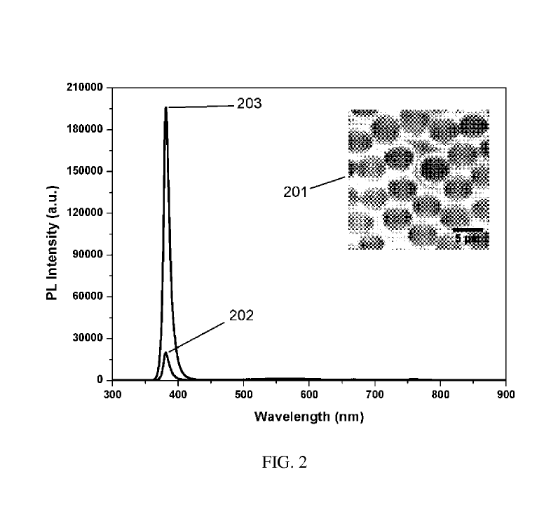

Fused silica (SiO₂) microspheres with average diameters of 5 μm were diluted by isopropanol to form a SiO₂ microsphere suspension 101. The microsphere concentration was about 1×10⁵ μL⁻¹. The suspension was drawn by a dropper 102 and then deposited onto the surface of zinc oxide (ZnO) film 104 grown on a silicon carbide (SiC) substrate 105 by drop coating 102. The film surface was therefore wetted 106. After the isopropanol in suspension was dried by spontaneous evaporation at room temperature, the close-packed microsphere monolayer 201 was self-assembled and the sandwich structure of SFMs was obtained. As shown in FIG. 2, the PL peak intensity excited from the sandwich structure 203 is 11 times higher than that excited from the film without capping with SiO₂ microspheres 202.

### EXAMPLE 2

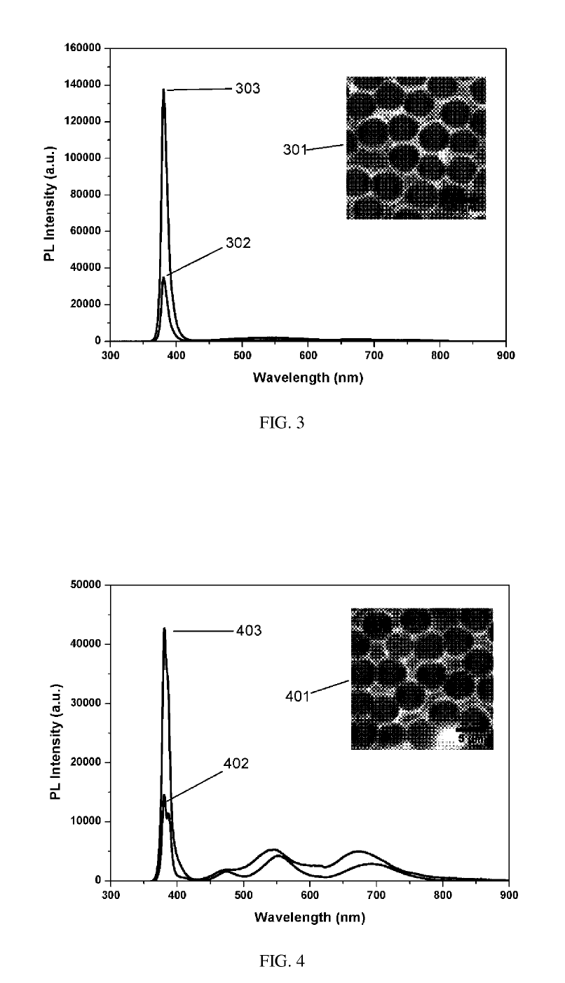

Fused silica (SiO₂) microspheres with average diameters of 5 μm were diluted by water to form a SiO₂ microsphere suspension 101. The microsphere concentration was about 4×10⁴ μL⁻¹. The suspension was drawn by a dropper 102 and then deposited onto the surface of zinc oxide (ZnO) film 104 grown on a titanium (Ti) substrate 105 by drop coating 102. The film surface was therefore wetted 106. After the water in suspension was dried by spontaneous evaporation at room temperature, the close-packed microsphere monolayer 301 was self-assembled and the sandwich structure of SFMs was obtained. As shown in FIG. 3, the PL peak intensity excited from the sandwich structure 303 is 3 times higher than that excited from the film without capping with SiO₂ microspheres 302.

### EXAMPLE 3

Fused silica (SiO₂) microspheres with average diameters of 5 μm were diluted by ethanol to form a SiO₂ microsphere suspension 101. The microsphere concentration was about 8×10⁴ μL⁻¹. The suspension was drawn by a dropper 102 and then deposited onto the surface of zinc oxide (ZnO) film 104 grown on a graphene substrate 105 by drop coating 102. The film surface was therefore wetted 106. After the ethanol in suspension was dried by spontaneous evaporation at room temperature, the close-packed microsphere monolayer 401 was self-assembled and the sandwich structure of SFMs was obtained. As shown in FIG. 4, the PL peak intensity excited from the sandwich structure 403 is 3 times higher than that excited from the film without capping with SiO₂ microspheres 402.

### EXAMPLE 4

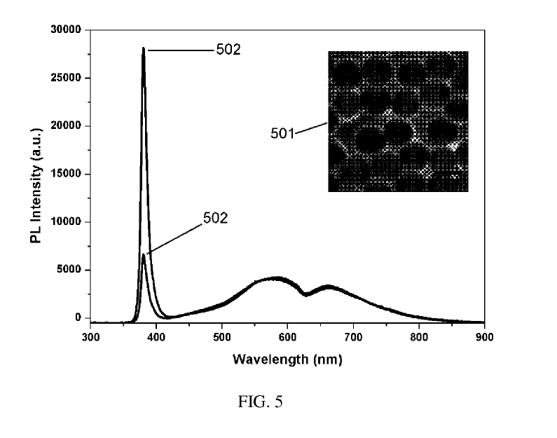

Fused silica (SiO₂) microspheres with average diameters of 5 μm were diluted by water to form a SiO₂ microsphere suspension 101. The microsphere concentration was about 1×10⁴ μL⁻¹. The suspension was drawn by a dropper 102 and then deposited onto the surface of zinc oxide (ZnO) film 104 grown on an alumina (Al₂O₃) substrate 105 by drop coating 102. The film surface was therefore wetted 106. After the water in suspension was dried by heating evaporation at 50° C., the close-packed microsphere monolayer 501 was self-assembled and the sandwich structure of SFMs was obtained. As shown in FIG. 5, the PL peak intensity excited from the sandwich structure 503 is 4 times higher than that excited from the film without capping with SiO₂ microspheres 502.

### EXAMPLE 5

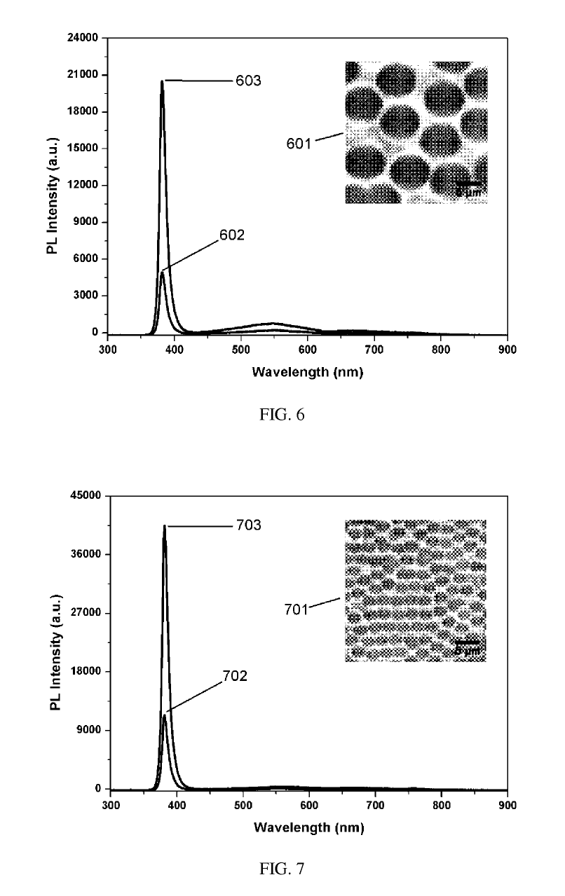

Fused silica (SiO₂) microspheres with average diameters of 7.5 μm were diluted by water to form a SiO₂ microsphere suspension 101. The microsphere concentration was about 2×10⁴ μL⁻¹. The suspension was drawn by a dropper 102 and then deposited onto the surface of zinc oxide (ZnO) film 104 grown on a silicon carbide (SiC) substrate 105 by drop coating 102. The film surface was therefore wetted 106. After the water in suspension was dried by blowing evaporation at room temperature, the close-packed microsphere monolayer 601 was self-assembled and the sandwich structure of SFMs was obtained. As shown in FIG. 6, the PL peak intensity excited from the sandwich structure 603 is 4 times higher than that excited from the film without capping with SiO₂ microspheres 602.

### EXAMPLE 6

Fused silica (SiO₂) microspheres with average diameters of 2.5 μm were diluted by water to form a SiO₂ microsphere suspension 101. The microsphere concentration was about 2×10⁵ μL⁻¹. The suspension was drawn by a dropper 102 and then deposited onto the surface of zinc oxide (ZnO) film 104 grown on a silicon carbide (SiC) substrate 105 by drop coating 102. The film surface was therefore wetted 106. After the water in suspension was dried by blowing and heating evaporation at 50° C., the close-packed microsphere monolayer 701 was self-assembled and the sandwich structure of SFMs was obtained. As shown in FIG. 7, the PL peak intensity excited from the sandwich structure 703 is 4 times higher than that excited from the film without capping with SiO₂ microspheres 702.

### EXAMPLE 7

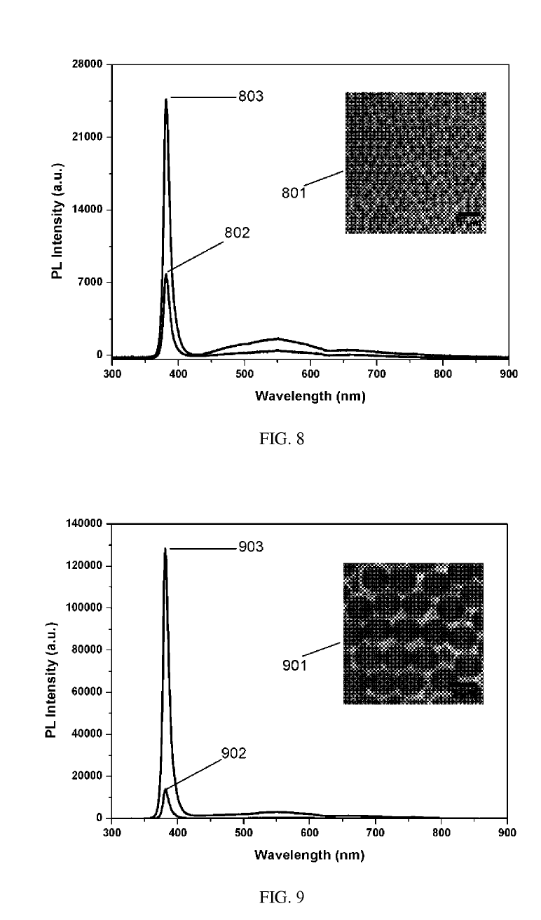

Fused silica (SiO₂) microspheres with average diameters of 1.5 μm were diluted by isopropanol to form a SiO₂ microsphere suspension 101. The microsphere concentration was about 1×10⁶ μL⁻¹. The suspension was sprayed onto the surface of zinc oxide (ZnO) film 104 grown on a silicon carbide (SiC) substrate 105 by a sprayer. The film surface was therefore wetted 106. After the isopropanol in suspension was dried by spontaneous evaporation at room temperature, the close-packed microsphere monolayer 801 was self-assembled and the sandwich structure of SFMs was obtained. As shown in FIG. 8, the PL peak intensity excited from the sandwich structure 803 is 3 times higher than that excited from the film without capping with SiO₂ microspheres 802.

### EXAMPLE 8

Polystyrene (PS) microspheres with average diameters of 5 μm were diluted by water to form a PS microsphere suspension 101. The microsphere concentration was about 4×10⁴ μL⁻¹. The zinc oxide (ZnO) film 104 grown on a silicon carbide (SiC) substrate 105 was immersed in the suspension and then vertically lifted out. The film surface was therefore wetted 106. After the water in suspension was dried by spontaneous evaporation at room temperature, the close-packed microsphere monolayer 901 was self-assembled and the sandwich structure of SFMs was obtained. As shown in FIG. 9, the PL peak intensity excited from the sandwich structure 903 is 11 times higher than that excited from the film without capping with PS microspheres 902.

### EXAMPLE 9

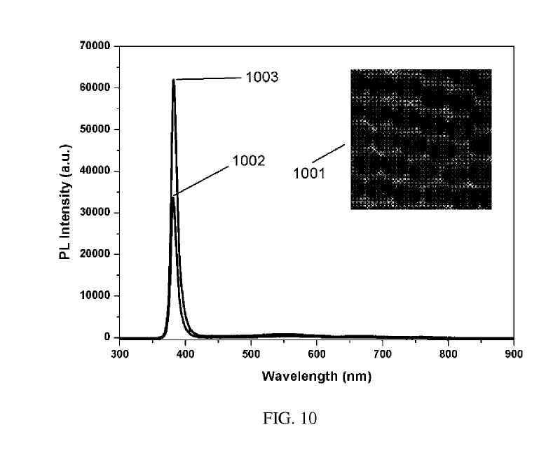

Polymethylmethacrylate (PMMA) microspheres with average diameters of 5.5 μm were diluted by water to form a PMMA microsphere suspension 101. The microsphere concentration was about 3.5×10⁴ μL⁻¹. The zinc oxide (ZnO) film 104 grown on a silicon carbide (SiC) substrate 105 was immersed in the suspension and then vertically lifted out. The film surface was therefore wetted 106. After the water in suspension was dried by heating evaporation at 50° C., the close-packed microsphere monolayer 1001 was self-assembled and the sandwich structure of SFMs was obtained. As shown in FIG. 10, the PL peak intensity excited from the sandwich structure 1003 is twice higher than that excited from the film without capping with PMMA microspheres 1002.

Although illustrative embodiments of the present invention have been described herein, it should be understood that the invention is not limited to the preferred embodiments and that various other changes and modifications may be made without departing from the spirit and scope of the invention as set forth in the following claims.

### OTHER PUBLICATIONS

R. H. Ritchie. Plasma losses by fast electrons in thin films. Physical Review, 106, 874-881, 1957.
K. H. Drexhage. Influence of a Dielectric Interface on Fluorescence Decay Time. Journal of Luminescence, 1-2, 693-701, 1970.
J. R. Lakowicz. Radiative Decay Engineering: Biophysical and Biomedical Applications. Analytical Biochemistry, 298, 1-24, 2001.
K. Okamoto, et al. Surface-Plasmon-Enhanced Light Emitters Based on InGaN Quantum Wells. Nature Materials, 3, 601-605, 2004.
P. Cheng, et al. Enhancement of ZnO Light Emission via Coupling with Localized Surface Plasmon of Ag Island Film. Applied Physics Letters, 92, 041119, 2008.
B. J. Lawrie, et al. Enhancement of ZnO Photoluminescence by Localized and Propagating Surface Plasmons. Optics Express, 17, 2565-2572, 2009.
T. N. Xu, et al. Photo Energy Conversion via Localized Surace Plasmons in ZnO/Ag/ZnO Nanostructures. Applied Surface Science, 258, 5886-5891, 2012

What is claimed is:

1. A sandwich structure for enhancement of photoluminescence from luminescent films, comprising:
a support, a luminescent film and a dielectric microsphere monolayer;
wherein the support is attached on one side of the luminescent film and the dielectric microspheres are applied on the other side of the luminescent film as a close-packed monolayer.

2. The sandwich structure according to claim 1, wherein the diameters of the dielectric microspheres are between 1.5 and 7.5 μm.

3. The sandwich structure according to claim 1, wherein the dielectric microsphere consists of fused silica, polystyrene, or polymethylmethacrylate.

4. The sandwich structure according to claim 1, wherein the luminescent film is selected from the group consisting of zinc oxide and any other commercial available luminescent films.

5. The sandwich structure according to claim 1, wherein the support is selected from the group consisting of titanium, silicon carbide, graphene, alumina and any other solid materials.

6. A process for fabricating a sandwich structure of support-film-microspheres for enhancement of photoluminescence from luminescent films, comprising the following steps:
i) diluting dielectric microspheres with a solvent to form suspension liquid;
ii) drawing the suspension liquid by a dropper;
iii) spreading the suspension liquid on a luminescent film fixed on a support;
iv) drying the suspension liquid resulting in a self-assembled close-packed microsphere monolayer on the surface of the luminescent film.

7. The process according to claim 6, wherein the solvent is volatile.

8. The process according to claim 7, wherein the volatile solvent is selected from the group consisting of water, ethanol and isopropanol.

9. The process according to claim 6, wherein the concentration of dielectric microspheres in the suspension liquid is between 10⁴˜10⁶ μL⁻¹.

10. The process according to claim 6, wherein the diameters of the dielectric microspheres are between 1.5 and 7.5 μm.

11. The process according to claim 6, wherein the suspension liquid is applied on the luminescent film by drop coating, spraying, or immersing.

12. The process according to claim 6, wherein drying the suspension liquid by spontaneous evaporation, heating evaporation, or blowing evaporation.

13. The process according to claim 6, wherein the close-packed microsphere monolayer is self-assembled during drying the suspension liquid.

14. The process according to claim 6, wherein the dielectric microsphere consists of fused silica, polystyrene, or polymethylmethacrylate.

17. The process according to claim 6, wherein the luminescent film is selected from the group consisting of zinc oxide and any other commercial available luminescent films.

18. The process according to claim 6, wherein the support is selected from the group consisting of titanium, silicon carbide, graphene, alumina and any other solid materials.
